(19) United States
(12) Patent Application Publication
(10) Pub. No.: US 2026/0272033 A1
(43) Pub. Date: Sep. 17, 2026

(54) AEROSOL GENERATING DEVICE AND AEROSOL GENERATING SYSTEM INCLUDING THE SAME

(71) Applicant: KT&G CORPORATION, Daejeon (KR)

(72) Inventors: Young Bum KWON, Gyeonggi-do (KR); Dong Sung KIM, Seoul (KR); Yong Hwan KIM, Gyeonggi-do (KR); Hun Il LIM, Seoul (KR)

(73) Assignee: KT&G CORPORATION, Daejeon (KR)

(21) Appl. No.: 18/994,446

(22) PCT Filed: Oct. 31, 2023
(86) PCT No.: PCT/KR2023/017079

§ 371 Date: Jan. 14, 2025

(30) Foreign Application Priority Data
Dec. 30, 2022 (KR) 10-2022-0191048
Mar. 8, 2023 (KR) 10-2023-0030811

(51) Int. Cl. A24F 40/465; A24F 40/57; H05B 6/06; H05B 6/10; H05B 6/44

(52) U.S. Cl. CPC A24F 40/465; A24F 40/57; H05B 6/06; H05B 6/105; H05B 6/44

(57) ABSTRACT

An aerosol generation system includes an aerosol generating article and an aerosol generating device configured to heat the aerosol generating article inserted into an accommodation space of the aerosol generating device, wherein the aerosol generating article includes a first susceptor arranged in a first portion and a second susceptor arranged in a second portion different from the first portion, and the aerosol generating device includes a first coil arranged in a first region of the accommodation space, a second coil arranged in a second region of the accommodation space that is different from the first region, and a controller configured to control power supplied to the first coil and the second coil.

### TECHNICAL FIELD

Various embodiments of the present disclosure relate to an aerosol generating device and an aerosol generating system including the aerosol generating device.

### BACKGROUND ART

Recently, the demand for alternative methods for overcoming the shortcomings of general cigarettes has increased. For example, there is an increasing demand for a system for generating aerosols by heating a cigarette or an aerosol generating material by using an aerosol generating device, rather than by burning cigarettes.

### DISCLOSURE OF INVENTION

### Technical Problem

As aerosol generating devices are increasingly used, the demand for customizing the amount of atomization and the taste of cigarettes has increased.

Various embodiments of the present disclosure may disclose customization of the amount of atomization and the taste of cigarettes to meet the preference of a user by independently controlling temperatures of a first portion and a second portion of an aerosol generating article.

Various embodiments of the present disclosure may detect insertion of an aerosol generating article by using an induction coil, without providing a separate sensor for detecting the insertion of the aerosol generating article.

Various embodiments of the present disclosure provide an aerosol generating device that may accurately measure a temperature of a heater in a non-contact manner.

The technical problems of the present disclosure are not limited to the above-described description, and other technical problems may be clearly understood by one of ordinary skill in the art from the embodiments to be described hereinafter.

### Solution to Problem

According to an aspect of the present disclosure, an aerosol generation system includes an aerosol generating article and an aerosol generating device configured to heat the aerosol generating article inserted into an accommodation space of the aerosol generating device, wherein the aerosol generating article includes a first susceptor arranged in a first portion and a second susceptor arranged in a second portion different from the first portion, the aerosol generating device includes a first coil arranged in a first region of the accommodation space, a second coil arranged in a second region of the accommodation space, wherein the second region is different from the first region, and a controller configured to control power supplied to the first coil and the second coil, an average thickness of the first susceptor is greater than an average thickness of the second susceptor, the controller is further configured to drive the first coil within a first frequency range in a first period and drive the second coil within a second frequency range in a second period, and a lower limit of the second frequency range is greater than an upper limit of the first frequency range.

According to another embodiment of the present disclosure, an aerosol generating device includes an accommodation space for accommodating an aerosol generating article, a first susceptor arranged in a first region of the accommodation space, a second susceptor arranged in a second region of the accommodation space that is different from the first region, a first coil wound on an outer side surface of the first region of the accommodation space, a second coil wound on an outer side surface of the second region of the accommodation space, and a controller configured to control power supplied to the first coil and the second coil, wherein an average thickness of the first susceptor is greater than an average thickness of the second susceptor, the controller is further configured to drive the first coil within a first frequency range in a first period and to drive the second coil within a second frequency range in a second period, and a lower limit of the second frequency range is higher than an upper limit of the first frequency range.

### Advantageous Effects of Invention

Various embodiments of the present disclosure may disclose customization of the amount of atomization and the taste of cigarettes to meet the preference of a user by independently controlling temperatures of a first portion and a second portion of an aerosol generating article.

Various embodiments of the present disclosure may detect insertion of an aerosol generating article by using an induction coil, without a separate sensor for detecting the insertion of an aerosol generating article.

Various embodiments of the present disclosure may accurately measure a temperature of a heater in a non-contact manner.

However, effects of the present disclosure are not limited to the above effects, and effects that are not mentioned could be clearly understood by one of ordinary skill in the art from the present specification and the attached drawings.

### BRIEF DESCRIPTION OF DRAWINGS

FIG. 1 is a perspective view of an aerosol generating device according to one embodiment.

FIG. 2 is a view illustrating an aerosol generating article according to one embodiment.

FIG. 3 is a schematic view illustrating components of an aerosol generating device according to one embodiment.

FIG. 4 is a schematic view illustrating components of an aerosol generating device according to another embodiment.

FIG. 5 is a schematic diagram illustrating thicknesses of a first susceptor and a second susceptor according to one embodiment.

FIG. 6 is a diagram illustrating control cycles of a first coil and a second coil according to one embodiment.

FIG. 7 is a diagram illustrating control cycles of a first coil and a second coil according to another embodiment.

FIG. 8 illustrates ranges of driving frequencies for driving the first coil and the second coil of FIG. 7 in first to fourth periods.

FIG. 9 illustrates a frequency response of the first coil according to one embodiment.

FIG. 10 illustrates a frequency response of the second coil according to a temperature change of the first susceptor according to one embodiment.

FIG. 11 illustrates a change in the frequency response of the second coil according to the temperature of the first susceptor according to one embodiment.

FIG. 12 is a block diagram of an aerosol generating device according to another embodiment.

### BEST MODE FOR CARRYING OUT THE INVENTION

An aerosol generation system according to an embodiment includes an aerosol generating article, and an aerosol generating device configured to heat the aerosol generating article inserted into an accommodation space of the aerosol generating device, wherein the aerosol generating article includes a first susceptor arranged in a first portion and a second susceptor arranged in a second portion different from the first portion, the aerosol generating device includes a first coil arranged in a first region of the accommodation space, a second coil arranged in a second region of the accommodation space, wherein the second region is different from the first region, and a controller configured to control power supplied to the first coil and the second coil, an average thickness of the first susceptor is greater than an average thickness of the second susceptor, the controller is further configured to drive the first coil within a first frequency range in a first period and drive the second coil within a second frequency range in a second period, and a lower limit of the second frequency range is greater than an upper limit of the first frequency range.

An aerosol generating device according to an embodiment includes an accommodation space for accommodating an aerosol generating article, a first susceptor arranged in a first region of the accommodation space, a second susceptor arranged in a second region of the accommodation space that is different from the first region, a first coil wound on an outer side surface of the first region of the accommodation space, a second coil wound on an outer side surface of the second region of the accommodation space, and a controller configured to control power supplied to the first coil and the second coil, wherein an average thickness of the first susceptor is greater than an average thickness of the second susceptor, the controller is further configured to drive the first coil within a first frequency range in a first period and to drive the second coil within a second frequency range in a second period, and a lower limit of the second frequency range is higher than an upper limit of the first frequency range.

A minimum thickness of the first susceptor may be greater than a maximum thickness of the second susceptor.

The first susceptor and the second susceptor may each be formed in a shape of a thin film.

The first period may not overlap the second period.

The controller may detect an inductance change through the first coil in a third period that does not overlap the first period or detect an inductance change through the second coil in a fourth period that does not overlap the second period.

The controller may determine, based on the inductance change, whether the aerosol generating article is inserted in the accommodation space.

The first period may not overlap the second period, and at least a part of the second period may overlap at least a part of the third period, or at least a part of the first period may overlap the fourth period.

The controller may sweep a driving frequency of the first coil within a third frequency range in a third period that does not overlap the first period, detect a change in a resonance frequency of the first coil based on a sweeping result of the driving frequency of the first coil, sweep a driving frequency of the second coil within a fourth frequency range in a fourth period that does not overlap the second period, and detect a change in a resonance frequency of the second coil based on a sweeping result of the driving frequency of the second coil.

The controller may calculate temperatures of the first susceptor and the second susceptor based on the changes in the resonance frequencies.

An upper limit of the third frequency range may be lower than a lower limit of the first frequency range, and a lower limit of the fourth frequency range may be higher than an upper limit of the second frequency range.

### MODE FOR THE INVENTION

With respect to the terms used to describe the various embodiments, general terms which are currently and widely used are selected in consideration of functions of structural elements in the various embodiments of the present disclosure. However, meanings of the terms may be changed according to intention, a judicial precedence, the appearance of new technology, and the like.

In addition, in certain cases, a term which is not commonly used may be selected. In such a case, the meaning of the term will be described in detail at the corresponding portion in the description of the present disclosure.

Therefore, the terms used in the various embodiments of the present disclosure should be defined based on the meanings of the terms and the descriptions provided herein.

In addition, unless explicitly described to the contrary, the word “comprise” and variations such as “comprises” or “comprising” will be understood to imply the inclusion of stated elements but not the exclusion of any other elements.

In addition, the terms “-er”, “-or”, and “module” described in the specification mean units for processing at least one function and operation and may be implemented by hardware components or software components and combinations thereof.

As used herein, expressions such as “at least one of,” when preceding a list of elements, modify the entire list of elements and do not modify the individual elements of the list.

For example, the expression, “at least one of a, b, and c,” should be understood as including only a, only b, only c, both a and b, both a and c, both b and c, or all of a, b, and c.

In an embodiment, an aerosol generating device may be a device that generates aerosols by electrically heating a cigarette accommodated in an interior space thereof.

The aerosol generating device may include a heater. In an embodiment, the heater may be an electro-resistive heater. For example, the heater may include an electrically conductive track, and the heater may be heated when currents flow through the electrically conductive track.

The heater may include a tube-shaped heating element, a plate-shaped heating element, a needle-shaped heating element, or a rod-shaped heating element, and may heat the inside or outside of a cigarette according to the shape of a heating element.

A cigarette may include a tobacco rod and a filter rod. The tobacco rod may be formed of sheets, strands, and tiny bits cut from a tobacco sheet. Also, the tobacco rod may be surrounded by a heat conductive material. For example, the heat conductive material may be, but is not limited to, a metal foil such as aluminum foil.

The filter rod may include a cellulose acetate filter. The filter rod may include at least one segment. For example, the filter rod may include a first segment configured to cool aerosols, and a second segment configured to filter a certain component in aerosols.

In another embodiment, the aerosol generating device may be a device that generates aerosols by using a cartridge containing an aerosol generating material.

The aerosol generating device may include a cartridge that contains an aerosol generating material, and a main body that supports the cartridge. The cartridge may be detachably coupled to the main body, but is not limited thereto. The cartridge may be integrally formed or assembled with the main body, and may also be fixed to the main body so as not to be detached from the main body by a user. The cartridge may be mounted on the main body while accommodating an aerosol generating material therein. However, the disclosure is not limited thereto. An aerosol generating material may also be injected into the cartridge while the cartridge is coupled to the main body.

The cartridge may contain an aerosol generating material in any one of various states, such as a liquid state, a solid state, a gaseous state, a gel state, or the like. The aerosol generating material may include a liquid composition. For example, the liquid composition may be a liquid including a tobacco-containing material having a volatile tobacco flavor component, or a liquid including a non-tobacco material.

The cartridge may be operated by an electrical signal or a wireless signal transmitted from the main body to perform a function of generating aerosols by converting the phase of an aerosol generating material inside the cartridge into a gaseous phase. The aerosols may refer to a gas in which vaporized particles generated from an aerosol generating material are mixed with air.

In another embodiment, the aerosol generating device may generate aerosols by heating a liquid composition, and the generated aerosols may be delivered to a user through a cigarette. That is, the aerosols generated from the liquid composition may move along an airflow passage of the aerosol generating device, and the airflow passage may be configured to allow aerosols to be delivered to a user by passing through a cigarette.

In another embodiment, the aerosol generating device may be a device that generates aerosols from an aerosol generating material by using an ultrasonic vibration method. In this case, the ultrasonic vibration method may refer to a method of generating an aerosol by atomizing an aerosol generating material by using ultrasonic vibration generated by a vibrator.

The aerosol generating device may include a vibrator, and the vibrator may generate a short period of vibration to atomize the aerosol generating material. The vibration generated by the vibrator may be an ultrasound vibration, and the frequency band of the ultrasound vibration may be about 100 kHz to about 3.5 MHz, but is not limited thereto.

The aerosol generating device may further include a wick that absorbs the aerosol generating material. For example, the wick may be arranged to wrap at least one area of the vibrator or to be in contact with at least one area of the vibrator.

As the voltage (e.g., AC voltage) is applied to the vibrator, heat and/or ultrasonic vibration may be generated from the vibrator, and the heat and/or ultrasonic vibration generated from the vibrator may be transmitted to the aerosol generating material absorbed into the wick. The aerosol generating material absorbed into the wick may be converted to a gas phase by heat and/or ultrasonic vibration transmitted from the vibrator, and as a result, aerosol may be generated.

For example, the viscosity of the aerosol generating material absorbed into the wick by the heat generated from the vibrator may be lowered, and the aerosol generating material of which the viscosity is lowered by the ultrasonic vibration generated from the vibrator may be divided into fine particles, thereby generating aerosol, but embodiments are not limited thereto.

In another embodiment, the aerosol generating device is a device that generates aerosols by heating an aerosol generating article accommodated in the aerosol generating device in an induction heating method.

The aerosol generating device may include a susceptor and a coil. In an embodiment, the coil may apply a magnetic field to the susceptor. As power is supplied to the coil from the aerosol generating device, a magnetic field may be formed inside the coil. In an embodiment, the susceptor may be a magnetic body that generates heat by an external magnetic field. As the susceptor is positioned inside the coil and a magnetic field is applied to the susceptor, the susceptor generates heat to heat an aerosol generating article. In addition, optionally, the susceptor may be positioned within the aerosol generating article.

In another embodiment, the aerosol generating device may further include a cradle.

The aerosol generating device may configure a system together with a separate cradle. For example, the cradle may charge a battery of the aerosol generating device. Alternatively, the heater may be heated when the cradle and the aerosol generating device are coupled to each other.

Hereinafter, the disclosure will now be described more fully with reference to the accompanying drawings, in which exemplary embodiments of the disclosure are shown such that one of ordinary skill in the art may easily work the disclosure. The disclosure may be implemented in a form that may be implemented in the aerosol generating devices of the various embodiments described above or may be implemented in various different forms, and is not limited to the embodiments described herein.

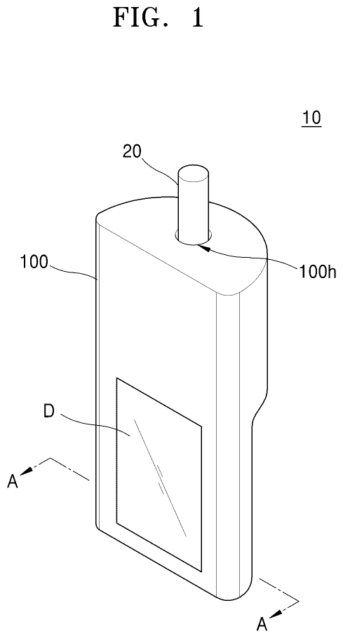

FIG. 1 is a perspective view of an aerosol generating apparatus according to an embodiment.

Referring to FIG. 1, an aerosol generating apparatus 10 according to an embodiment may include a housing 100 into which an aerosol generating article 20 may be inserted.

The housing 100 may constitute the overall appearance of the aerosol generating apparatus 10, and may include an internal space (or an ‘arrangement space’) in which components of the aerosol generating apparatus 10 may be arranged. In the drawings, only embodiments wherein the cross-section of the housing 100 is formed in a semicircular shape are illustrated, but the shape of the housing 100 is not limited thereto. According to an embodiment (not shown), the housing 100 may be formed entirely in a cylindrical form or a polygonal column (e.g., a triangular column or a square column).

Components for generating an aerosol by heating the aerosol generating article 20 inserted into the housing 100, and components for detecting an amount of moisture of the aerosol generating article 20 may be arranged inside the housing 100, and a detailed description thereof will be provided later.

In an embodiment, the housing 100 may include an accommodation space 100h through which the aerosol generating article 20 may be inserted into the housing 100. At least a portion of the aerosol generating article 20 may be inserted into or accommodated in the housing 100 through the accommodation space 100h.

The aerosol generating article 20 inserted into or accommodated in the housing 100 may be heated inside the housing 100, and thus, an aerosol may be generated from the aerosol generating article 20. The aerosol generated from the aerosol generating article 20 may be discharged to the outside of the aerosol generating device 10 through the aerosol generating article 20 and/or a space between the aerosol generating article 20 and the accommodation space 100h, and the user may inhale the aerosol discharged to the outside.

The aerosol generating device 10 according to an embodiment may further include a display D on which visual information is displayed.

The display D may be positioned such that at least an area thereof is exposed to the outside of the housing 100. For example, at least an area of the display D may be exposed to the outside of the housing 100 through a cover glass of the housing 100, but embodiments are not limited thereto.

The aerosol generating device 10 may output various visual information through the display D or may control operations of the components of the aerosol generating device 10 based on a user input that is input on the display D.

In an embodiment, the aerosol generating device 10 may output information such as a pre-heating time or the number of puffs regarding the aerosol generating article 20 inserted into the accommodation space 100h through the display D. However, the information output through the display D is not limited to the above-described embodiment.

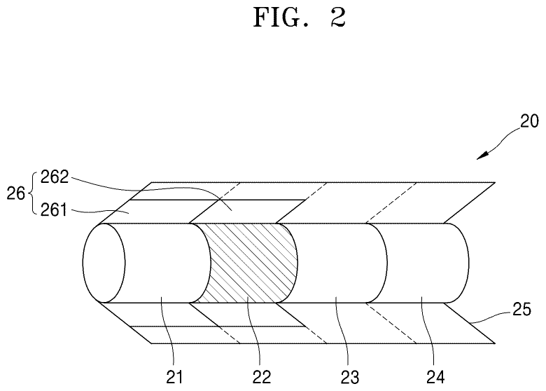

In another embodiment, the aerosol generating device 10 may detect a user input that is input on the display D, and may control power supplied to the heater (not shown) heating the aerosol generating article 20 inserted based on the user input, but embodiments are not limited thereto. FIG. 2 is a view illustrating an aerosol generating article according to an embodiment. FIG. 2 schematically shows a structure of the aerosol generating article 20, and the aerosol generating article 20 of FIG. 2 may be an embodiment of the aerosol generating article inserted in the aerosol generating device 10 of FIG. 1.

Referring to FIG. 2, the aerosol generating article 20 according to an embodiment may include a first portion 21, a second portion 22, a third portion 23, and a fourth portion 24.

Each of the first portion 21, the second portion 22, the third portion 23, and the fourth portion 24 may include an aerosol generating element, a tobacco element, a cooling element, and a filter element. For example, the first portion 21 may include an aerosol generating material, the second portion 22 may include a tobacco material and a moisturizer, the third portion 23 may cool a current passing through the first portion 21 and/or the second portion 22, and the fourth portion 24 may include a filter material.

In an embodiment, the first portion 21, the second portion 22, the third portion 23, and the fourth portion 24 may be arranged sequentially in a longitudinal direction of the aerosol generating article 20. In the disclosure, the longitudinal direction of the aerosol generating article 20 may be a direction in which a length of the aerosol generating article 20 extends. A longitudinal direction of the aerosol generating article 20 may refer to, for example, a direction from the first portion 21 to the fourth portion 24.

The first portion 21 and/or the second portion 22 of the aerosol generating article 20 may be heated by the aerosol generating device (e.g., the aerosol generating device 10 of FIG. 1) to generate an aerosol. Because the first portion 21, the second portion 22, the third portion 23, and the fourth portion 24 are aligned based on the longitudinal direction of the aerosol generating article 20, the aerosol generated in the first portion 21 and the second portion 22 may sequentially pass through the first portion 21, the second portion 22, the third portion 23, and the fourth portion 24 and form an air flow. Accordingly, the user may put one's mouth on the fourth portion 24 and inhale the aerosol discharged from the fourth portion 24.

The first portion 21 may include an aerosol generating element. In addition, the first portion 21 may also contain other additives such as flavors, a wetting agent, and/or organic acid, and may contain a flavored liquid such as menthol or a moisturizer. The aerosol generating element may include at least one of, for example, glycerin, propylene glycol, ethylene glycol, dipropylene glycol, diethylene glycol, triethylene glycol, tetraethylene glycol, and oleyl alcohol. The aerosol generating element is not limited to the above embodiment, and the first portion 21 may further include various types of aerosol generating elements according to embodiments.

The first portion 21 may include a wound sheet, and the aerosol generating element may be included in the first portion 21 by being impregnated in the wound sheet. In addition, other additives such as flavors, a wetting agent, and/or organic acid may be included in the first portion 21 in a state of being absorbed into the wound sheet.

The wound sheet may include, for example, at least one of a paper, cellulose acetate, lyocell, and polylactic acid. For example, the wound sheet may be a paper sheet that does not generate a smell due to heat even when heated to a high temperature, but embodiments are not limited thereto.

The second portion 22 may include a tobacco element. The tobacco element may include a certain type of tobacco material. For example, the tobacco element may include a type of pipe tobacco, a type of tobacco particle, a type of tobacco sheet, a type of tobacco beads, a type of tobacco granule, a type of tobacco powder, or a type of tobacco extract. Also, the tobacco material may include for example at least one type from a tobacco leaf, lateral veins of tobacco leaves, a puff tobacco, a cut tobacco pipe, a tobacco sheet, and a reformulated tobacco.

The third portion 23 may cool a current passing through the first portion 21. The third portion 23 may be made of a polymer material or a biodegradable polymer material and may have a cooling function. For example, the third portion 23 may be made of a polyactic acid (PLA) fiber, but is not limited thereto. Alternatively, the third portion 23 may be made of a cellulose acetate filter having a plurality of holes. However, the third portion 23 is not limited to the above-described examples and may include any material which may cool aerosol without limit. For example, the third portion 23 may include a tube filter or a paper pipe including a cavity.

The third portion 23 may include a tube-type structure including a cavity, and an inner surface of the cavity may be coated with at least one type of material selected from the group consisting of PLA and a flavor material.

The PLA is coated on the inner surface of the cavity and causes phase variation and may effectively cool the aerosol. For example, the PLA may cause phase variation, such as fusion of absorbing heat energy or glass transition. The heat energy of the aerosol passing through the inner surface of the cavity may be used for the phase variation of the PLA, and thus, the temperature of the aerosol may be effectively reduced.

The flavor material coated on the inner surface of the cavity may add a flavor to the aerosol passing through the inner surface of the cavity. The flavor material may refer to a material for adding a specific flavor. For example, the flavor material may include vegetable spices, such as cinnamon, sage, herb, chamomile, winter hay, lavender, bergamot, a lemon, an orange, cinnamon, jasmine, ginger, vanilla, spearmint, peppermint, acacia, coffee, salary, sandalwood, cocoa, etc.

As another example, the flavor material may include animal spices, such as musk, ambergris, civet, castoreum, etc.

As another example, the flavor material may include an alcohol-based compound, such as menthol, geraniol, linalol, anethol, eugenol, etc. Also, the flavor material may include an aldehyde-based compound, such as vanillin, benzaldehyde, anisaldehyde, etc. Also, the flavor material may include an ester-based compound, such as isoamyl acetate, linalyl acetate, isoamyl propionate, linalyl butyrate, etc. Preferably, the flavor material may include menthol.

The fourth portion 24 may include a filter material. For example, the fourth portion 24 may be a cellulose acetate filter. The shape of the fourth portion 24 is not limited. For example, the fourth portion 24 may be a cylindrical-type rod or a tube-type rod including a hollow therein. In addition, the fourth portion 24 may be a recess-type rod. If the fourth portion 24 includes a plurality of segments, at least one of the plurality of segments may also have a different shape.

The fourth portion 24 may be formed to generate flavors. For example, a liquid flavor material may be injected into the fourth portion 24, or an additional fiber impregnated with a flavor material may be inserted into the fourth portion 24. For example, the additional fiber impregnated with the flavor material may be arranged in the fourth portion 24 in a direction parallel to the longitudinal direction of the aerosol generating article 20. The additional fiber impregnated with the flavor material may be formed by using a material, such as cellulose acetate, cotton, PLA, etc., but it is not limited thereto. Also, with respect to the additional fiber impregnated with the flavor material, the amount of impregnated flavor material may be controlled by adjusting a thickness of the fiber, the number of strands of the fiber, etc.

Also, the fourth portion 24 may include at least one capsule. For example, the capsule may include a flavor material, and when the capsule is broken, a flavor may be generated due to the leaked flavor material. As another example, the capsule may include an aerosol generating material, and when the capsule is broken, aerosol may be generated from the leaked material. The capsule may have a structure in which the aerosol generating material is wrapped by a thin film. The capsule may have a spherical or a cylindrical shape, but is not limited thereto.

The aerosol generating article 20 according to an embodiment may further include a wrapper 25 and a thermally conductive thin film 26 wrapping at least a portion of the first portion 21 to the fourth portion 24.

The wrapper 25 may be located at an outermost end of the aerosol generating article 20, and may wrap at least a portion of the first portion 21 to the fourth portion 24 or wrap all of the first portion 21 to the fourth portion 24, but embodiments are not limited thereto. In addition, the wrapper 25 may be a single wrapper, but may also be a combination of a plurality of wrappers according to an embodiment.

When the thermally conductive thin film 26 is inserted into the aerosol generating device (e.g., the aerosol generating device 10 of FIG. 1), the thermally conductive thin film 26 may be located in a position corresponding to the heater to uniformly distribute heat generated from the heater to the first portion 21 and/or the second portion 22.

In an embodiment, the thermally conductive thin film 26 may include a material having excellent thermal conductivity, and may be positioned to wrap the first portion 21 and/or the second portion 22 heated by the heater of the aerosol generating device to uniformly distribute heat generated from the heater to the first portion 21 and/or the second portion 22. For example, the thermally conductive thin film 26 may include at least one of aluminum, platinum, and rutinum, which have excellent thermal conductivity, but embodiments are not limited thereto.

In an embodiment, the size, shape, material, and the like of the thermally conductive thin film 26 may change according to the type of the aerosol generating article 20. Accordingly, the aerosol generating device may detect the type of the aerosol generating article 20 and/or the movement of the aerosol generating article 20 based on the electrical characteristic changes inside the aerosol generating device due to the thermally conductive thin film 26 of the aerosol generating article 20, and details thereof will be described later.

According to one embodiment, the thermally conductive thin film 26 may directly generate heat by an alternating magnetic field generated by an induction coil. That is, the thermally conductive thin film 26 may function as a susceptor that is inductively heated by an induction coil.

The thermally conductive thin film 26 may include a first susceptor 261 arranged in the first portion and a second susceptor 262 arranged in the second portion. The first susceptor 261 may be separated from the second susceptor 262 by a certain distance. Heating of the first susceptor 261 and the second susceptor 262 may be independently controlled, and accordingly, temperatures of the first portion and the second portions of the aerosol generating article may be independently controlled. As a result, a user may customize the amount of atomization and the taste of a cigarette to meet the preference of the user.

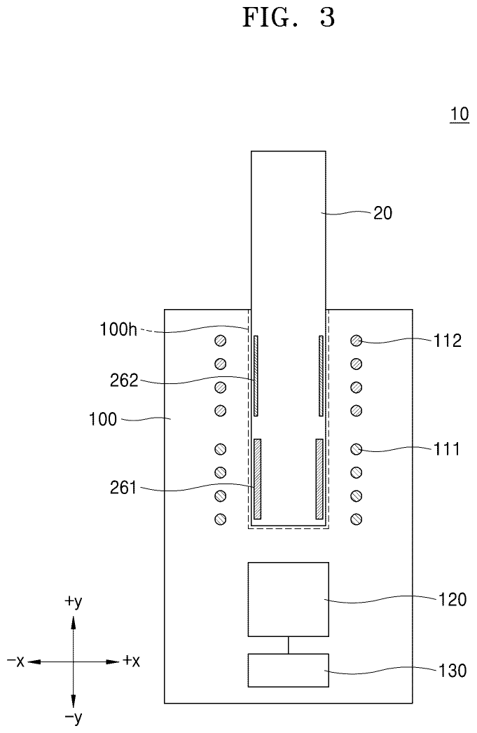

FIG. 3 is a schematic view illustrating components of an aerosol generating device according to one embodiment.

FIG. 3 is a cross-sectional view of the aerosol generating device 10 of FIG. 1, which is taken along line A-A′, and illustrates some components in a housing 100. Additionally, an aerosol generating article 20 inserted into an aerosol generating device 10 of FIG. 3 may be the aerosol generating article 20 of FIG. 2, and redundant descriptions thereof are omitted below.

Referring to FIG. 3, the aerosol generating device 10 (for example, the aerosol generating device 10 of FIG. 1) according to one embodiment may include the housing 100 (for example, the housing 100 of FIG. 1), a heater, a controller 120, a battery 130, and a sensor 140. Components of the aerosol generating device 10 according to one embodiment are not limited thereto, and at least one component may be added to the aerosol generating device 10, or at least one component may be omitted from the aerosol generating device 10 depending on embodiments.

The housing 100 may include an internal space in which components of the aerosol generating device 10 may be placed. For example, the heater, the controller 120, the battery 130, and the sensor 140 may be in the inner space of the housing 100, but components in the inner space are not limited to the embodiment described above.

According to one embodiment, the housing 100 may include an accommodation space 100h into which the aerosol generating article 20 may be inserted or in which the aerosol generating article 20 may be accommodated. For example, at least a portion of the aerosol generating article 20 may be inserted into the housing 100 or may be accommodated inside the housing 100 through the accommodation space 100h.

The heater may be in the inner space of the housing 100 and may generate an aerosol by heating the aerosol generating article 20 inserted into or accommodated inside the housing 100. For example, the heater may generate heat as power is supplied from the battery 130 to the heater and may heat at least a portion of the aerosol generating article 20. The vaporized particles generated as the aerosol generating article 20 is heated may be mixed with the air introduced into the housing 100 to generate an aerosol.

According to one embodiment, the heater may include an induction heating-type heater. For example, the heater may include an induction coil that generates an alternating magnetic field as power is supplied, and a susceptor that generates heat by the alternating magnetic field generated by the induction coil. According to one embodiment, the heater may include at least two heaters to independently control heating of two different regions of the accommodation space 100h into which an aerosol generating article is inserted.

The induction coil may include a first coil 111 and a second coil 112. The first coil 111 may be in a first region of the accommodation space 100h, and the second coil 112 may be in a second region of the accommodation space 100h that is different from the first region of the accommodation space 100h. The first region of the accommodation space 100h is adjacent to a first portion of the aerosol generating article 20 inserted into the accommodation space 100h, and the second region of the accommodation space 100h may be adjacent to a second portion of the aerosol generating article 20 inserted into the accommodation space 100h. The controller may supply independent alternating currents to the first coil 111 and the second coil 112. The controller independently may independently control the alternating currents supplied to the first coil 111 and the second coil 112 such that the first susceptor 261 and the second susceptor 262 may independently control heating. That is, temperatures of the first and second portions of the aerosol generating article 20 may be controlled independently, and accordingly, a user may customize the amount of atomization and the taste of a cigarette to meet preference of the user.

In one embodiment, the first coil 111 and the second coil 112 may respectively surround outer circumferential surfaces of the first susceptor 261 and the second susceptor 262, and the first susceptor 261 and the second susceptor 262 may each surround at least a portion of the outer circumferential surface of the aerosol generating article 20 inserted into or accommodated inside the housing 100. For example, the first susceptor 261 and the second susceptor 262 may surround at least a part of a portion (for example, the first portion 21 in FIG. 2) including an aerosol generating material of the aerosol generating article 20 and/or a portion including tobacco material (for example, the second portion 22 in FIG. 2), but is not limited thereto.

The controller 120 may control all operations of the aerosol generating device 10. In one example, the controller 120 may be electrically or operatively connected to the heater and the battery 130 to control the power supplied from the battery 130 to the heater.

In the present disclosure, the expression “operatively connected” may mean a state in which components are connected to exchange signals through wireless communication or exchange optical signals, magnetic signals, and/or so on, and the expression may be used in the same meaning below.

The battery 130 may supply power required for operation of the aerosol generating device 10. For example, the battery 130 may supply power to the heater to heat the aerosol generating article 20. In another example, the battery 130 may also supply power required for an operation of the controller 120.

In one embodiment, the first coil 111 and the second coil 112 may be used to detect whether the aerosol generating article 20 is inserted in the accommodation space 100h.

In one embodiment, the first coil 111 and the second coil 112 may be used to detect temperatures of the first susceptor 261 and the second susceptor 262. Specifically, temperatures of the first susceptor 261 and the second susceptor 262 may be calculated through a change in resonance frequencies of the first coil 111 and the second coil 112. Resistance values of the first susceptor 261 and the second susceptor 262 change depending on temperature, and accordingly, impedance values viewed from the first coil 111 and the second coil 112 change. When the impedance values viewed from the first coil 111 and the second coil 112 changes, resonance frequencies of the first coil 111 and the second coil 112 also change, and accordingly, temperatures of the first susceptor 261 and the second susceptor 262 may be inferred from the change in resonance frequencies of the first coil 111 and the second coil 112.

In one embodiment, the controller 120 may determine whether the aerosol generating article 20 is inserted in the accommodation space 100h through the first coil 111 and the second coil 112.

As the aerosol generating article 20 includes a thermally conductive thin film 26 (for example, the thermally conductive thin film 26 of FIG. 2) therein, when the aerosol generating article 20 is inserted into the accommodation space 100h, electrical characteristics in the accommodation space 100h may change. Accordingly, the controller 120 may detect a change in electrical characteristics in the accommodation space 100h through the first coil 111 and the second coil 112 and determine whether an aerosol generating article is inserted in the accommodation space 100h based on the detection result. For example, the controller 120 may detect a change in inductance in the accommodation space 100h through the first coil 111 and the second coil 112 and determine whether the aerosol generating article 20 is inserted in the accommodation space 100h based on the detection result.

In one embodiment, the controller 120 may calculate temperatures of the first susceptor 261 and the second susceptor 262 by detecting a change in resonance frequencies of the first coil 111 and the second coil 112.

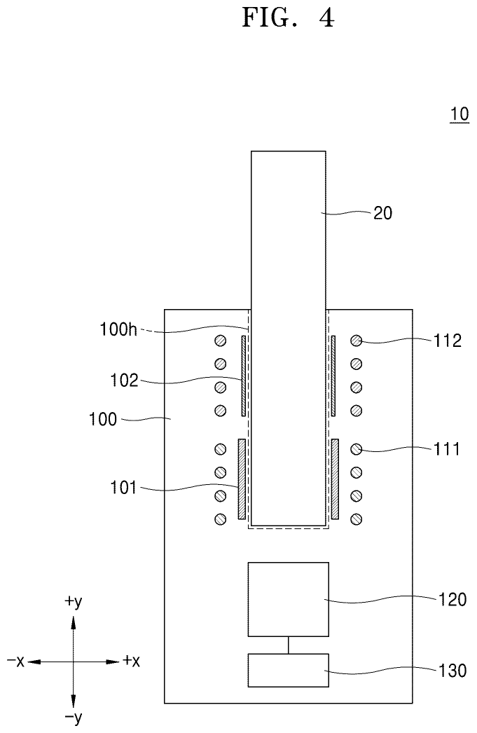

FIG. 4 is a schematic view illustrating components of an aerosol generating device according to another embodiment.

Unlike the embodiment of FIG. 3, in the embodiment of FIG. 4, a first susceptor 101 and a second susceptor 102 are arranged in the accommodation space 100h of an aerosol generating device.

Specifically, the first susceptor 101 is arranged in a first region of the accommodation space 100h, and the second susceptor 102 is arranged in a second region of the accommodation space 100h that is different from the first region. The first region of the accommodation space 100h is adjacent to a first portion of the aerosol generating article 20 inserted into the accommodation space 100h, and the second region of the accommodation space 100h is adjacent to a second portion of the aerosol generating article 20 inserted into the accommodation space 100h.

The first coil 111 may be wound on an outer side surface of the first region of the accommodation space 100h, and the second coil 112 may be wound on an outer side surface of the second region of the accommodation space 100h.

In the embodiment of FIG. 4, the first susceptor 101 and the second susceptor 102 may be in the accommodation space 100h, and accordingly, the thermally conductive membrane 26 (see FIG. 2) may be omitted from the aerosol generating article 20. However, the embodiment of the present disclosure is not limited thereto, and although omitted in FIG. 4, the aerosol generating article 20 may include the thermally conductive thin film 26 (see FIG. 2). The thermally conductive thin film may include a metal material with excellent thermal conductivity and may be directly heated by the first coil 111 and the second coil 112. Also, the thermally conductive thin film may evenly transfer the heat generated by a susceptor to the first portion and the second portion of the aerosol generating article 20.

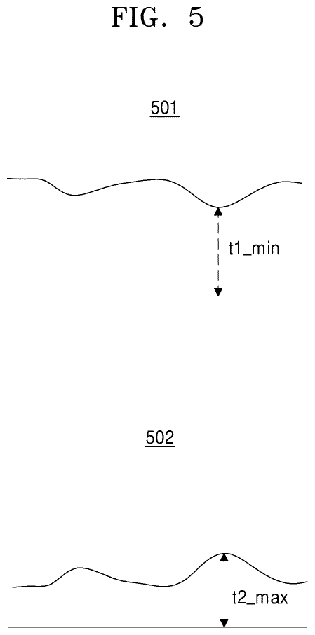

FIG. 5 is a schematic diagram illustrating thicknesses of a first susceptor and a second susceptor according to one embodiment.

A first susceptor 501 and a second susceptor 502 illustrated in FIG. 5 may respectively correspond to the first susceptor 261 and the second susceptor 262 included in the aerosol generating articles illustrated in FIGS. 2 and 3, or the first susceptor 101 and the second susceptor 102 included in the aerosol generating device.

Referring to FIGS. 2 to 4, the aerosol generating device of the present disclosure generates an aerosol by heating the aerosol generating article 20 by using an induction heating method. In order to customize the amount of atomization and the taste of a cigarette to meet preference of a user, it is preferable to independently heat and control temperatures of the first portion 21 and the second portion 22 of the aerosol generating article 20. However, the embodiments of the present disclosure adopt an induction heating method, and the first portion 21 is electromagnetically coupled to the second portion 22, and accordingly, it is difficult to independently control heating of the first portion 21 and the second portion 22.

Referring to FIG. 3, the heater that heats the aerosol generating article 20 inserted into the aerosol generating device 10 includes a first heater and a second heater. The first heater includes the first susceptor 261 included in the aerosol generating article 20 and the first coil 111 included in the aerosol generating device 10, and the second heater includes the second susceptor 262 included in the aerosol generating article 20 and the second coil 112 included in the aerosol generating device 10.

In order to independently control heating of the first heater and heating of the second heater, it is preferable that a magnetic field generated by the first coil 111 affects only the first susceptor 261 and a magnetic field generated by the second coil 112 affects only the second susceptor 262. However, the first coil 111 may be adjacent to the second coil 112, and the first susceptor 261 may also be adjacent to the second susceptor 262. Therefore, a magnetic field generated by the first coil 111 affects not only the first susceptor 261 but also the second susceptor 262. Likewise, a magnetic field generated by the second coil 112 affects not only the second susceptor 262 but also the first susceptor 261.

In order to solve this problem, in the present disclosure, heating of the first heater and heating of the second heater may be controlled independently of each other by taking advantage of the fact that a skin effect of an induction current has frequency-dependent characteristics.

The induction heating method uses the skin effect caused by the induction current, and when a high-frequency current is applied to a coil, a high-frequency magnetic flux that vertically penetrates through a surface of a susceptor is formed. An induction current is induced on an outer circumferential surface of the susceptor by the high-frequency magnetic flux, and the susceptor is heated by Joule heating generated by resistance of the susceptor. The induction current increases towards an outer circumferential surface of a conductive material and decreases exponentially towards an inner portion, which is a skin effect of an induction current.

A current penetration depth P is an important indicator that indicates a depth from an outer circumferential surface of a susceptor which can be heated by the induction current. The current penetration depth P is defined as the distance at which the intensity (magnitude) of an induction current is attenuated to 1/e (0.368) of the intensity of the induction current on the outer circumferential surface, and is represented by Equation 1 below.

$$P = \frac{1}{\sqrt{π f μ σ}} \qquad Equation 1$$

(f: frequency, μ: permeability, σ: conductivity)

According to Equation 1 above, it can be seen that the current penetration depth P decreases as the frequency f increases and increases as the frequency f decreases.

By making a thickness of the first susceptor 261 different from a thickness of the second susceptor 262 and setting the frequency of an alternating current supplied to the first coil 111 to be different the frequency of an alternating current of the second coil 112, heating of the first heater and heating of the second heater may be controlled independently of each other.

Specifically, as illustrated in FIG. 5, an average thickness of the first susceptor 261 is configured to be greater than an average thickness of the second susceptor 262, and the frequency of an alternating current supplied to the first coil 111 is set to be lower than the frequency of an alternating current supplied to the second coil 112. However, the embodiments of the present disclosure are not limited thereto, and in contrast to the embodiment of FIG. 5. For example, the average thickness of the first susceptor 261 may be configured to be smaller than the average thickness of the second susceptor 262 and the frequency of the alternating current supplied to the first coil 111 may be set to higher than the frequency of the alternating current supplied to the second coil 112.

The frequency of the alternating current supplied to the first coil 111 is relatively low, and accordingly, a penetration depth thereof is great. Accordingly, an induction current of the first coil 111 is less induced in the second susceptor 262 having a relatively thin average thickness. As a result, the induction current induced from the first coil 111 to the second susceptor 262 is small, and accordingly, the second susceptor 262 is not sufficiently heated.

By contrast, the frequency of the alternating current supplied to the second coil 112 is relatively high, and accordingly, a penetration depth is small. Therefore, the induction current induced from the second coil 112 to the first susceptor 261 does not flow throughout the first susceptor 261 having a relatively great average thickness and is concentrated on a surface that is a part of the first susceptor 261. Since a thickness of the first susceptor 261 is greater than the penetration depth, the resistance of the first susceptor 261 is relatively small. As a result, the induction current induced from the second coil 112 does not sufficiently heat the first susceptor 261 due to the low resistance of the first susceptor 261.

The first coil 111 and the second coil 112 may be driven by currents of a single frequency but may also be driven within a certain frequency range. In this case, in order to greatly reduce that the first heater and the second heater affect each other, it is preferable to set a lower limit of a second frequency range for driving the second coil 112 to be greater than an upper limit of a first frequency range for driving the first coil 111.

As illustrated in FIG. 5, a thickness of the first susceptor 501 and a thickness of the second susceptor 502 may not be constant. In order to greatly reduce that the first heater and the second heater affect each other, it is preferable that the minimum thickness t1_min of the first susceptor 501 is greater than the maximum thickness t2_max of the second susceptor 502.

As such, in the embodiments of the present disclosure, the thickness of the first susceptor 501 is different from the thickness of the second susceptor 502, the frequency of the alternating current supplied to the first coil 111 is different from the frequency of the alternating current supplied to the second coil 112, and accordingly, heating of the first heater and heating of the second heater may be controlled independently of each other.

As a result, the aerosol generating device 10 according to one embodiment may independently control temperatures of the first portion and the second portion of the aerosol generating article 20 inserted into the aerosol generating device 10, and as a result, a user may customize the amount of atomization and the taste of a cigarette to meet preference of the user.

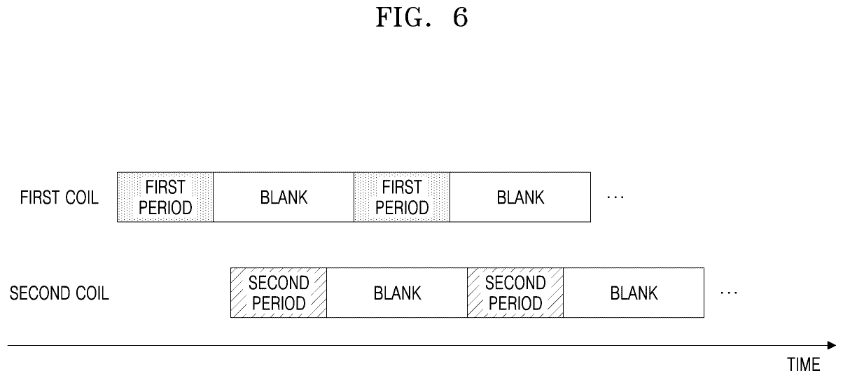

FIG. 6 is a diagram illustrating control cycles of the first coil and the second coil according to one embodiment.

Referring to FIGS. 3, 4, and 6, the first coil 111 is positioned close to the second coil 112, and accordingly, there may be mutual inductance. When there is mutual inductance, heating control of the first coil 111 and the second coil 112 may be unstable due to influence of the mutual inductance.

In order to remove the influence of the mutual inductance between the first coil 111 and the second coil 112, the present disclosure provides a method of heating and driving the first coil 111 and the second coil 112 by time division.

The controller 120 may drive the first coil 111 within a first frequency range in a first period and drive the second coil 112 within a second frequency range in a second period. The first period may be a heating period of the first coil 111, and the second period may be a heating period of the second coil 112. As illustrated in FIG. 6, the first period does not overlap the second period, and thus, the first coil 111 may be heated and driven by time division of the second coil 112.

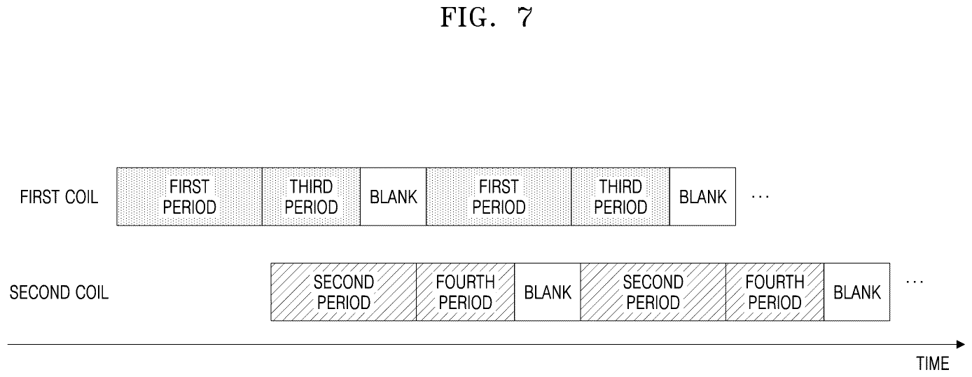

As illustrated in FIG. 6, in one embodiment, a blank period may be inserted between the first period and the first period. Likewise, a blank period may be inserted between the second period and the second period. The controller 120 may detect an inductance change during a part of the blank period or may use the blank period as a detection period for detecting an impedance change. Detailed descriptions thereof are given below with reference to FIG. 7.

FIG. 7 is a diagram illustrating control cycles of a first coil and a second coil according to another embodiment.

Referring to FIGS. 3 to 4 and FIG. 7, the controller 120 may drive the first coil 111 in a first period and a third period which does not overlap the first period. Also, the controller 120 may drive the second coil 112 in a second period and a fourth period that does not overlap the second period.

Here, the first period is a period in which an alternating current in a first frequency range is supplied to the first coil 111, and the second period is a period in which an alternating current in a second frequency range is supplied to the second coil 112. In other words, the first period is a heating period in which the first coil 111 inductively heats the first susceptor, and the second period is a heating period in which the second coil 112 inductively heats the second susceptor.

The third period is a detection period in which the controller 120 detects an inductance change or an impedance change through the first coil 111. The fourth period is a detection period in which the controller 120 detects an inductance change or an impedance change through the second coil 112. The controller 120 may determine whether the aerosol generating article 20 is inserted in an accommodation space of the aerosol generating device 10 based on the inductance change detected in the third period or the fourth period. Additionally, the controller 120 may calculate temperatures of the first susceptor and the second susceptor based on the impedance change detected in the third period and the fourth period.

As illustrated in FIG. 7, it is preferable that the first period does not overlap the second period. This is because, when an inductance change or an impedance change is detected through the first coil 111 in the first period in which the first coil 111 inductively heats the first susceptor, the inductance change or impedance change may act as noise in the induction heating control of the first susceptor. For the same reason, it is preferable that the second period does not overlap the fourth period.

By contrast, as illustrated in FIG. 7, it is preferable that the second period and the third period of a control period overlap at least partially, or the first period and fourth period overlap at least partially. As such, an idle period in which the first coil 111 and the second coil 112 do not perform a heating operate is minimized, thereby preventing insufficient heating of the aerosol generating device 10. The idle period of the first coil 111 is a combination of the third period and a blank period, and the idle period of the second coil 112 is a combination of the fourth period and a blank period.

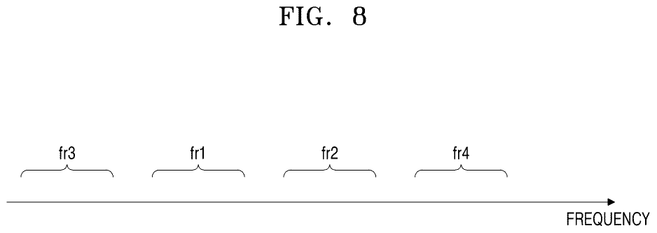

FIG. 8 illustrates ranges of driving frequencies for driving the first coil and the second coil of FIG. 8 in the first to fourth periods.

The aerosol generating device 10 according to an embodiment may control amplitudes and frequencies of alternating currents applied to the first coil and the second coil.

Referring to FIGS. 3 to 8, the frequency increases in the order of a third frequency range fr3 for driving the first coil 111 in the third period which is the lowest frequency band, a first frequency range fr1 for driving the first coil 111 in the first period, a second frequency range fr2 for driving the second coil 112 in the second period, and a fourth frequency range fr4 for driving the second coil 112 in the fourth period which is the highest frequency band. The example illustrated in FIG. 8 assumes the embodiments of FIGS. 3 to 5 in which average thicknesses of the first susceptors 101 and 261 are greater than average thicknesses of the second susceptors 102 and 262.

It is preferable that the first to fourth frequency ranges fr1 through fr4 do not overlap each other. This is because, when the frequency ranges overlap each other, the frequency ranges may interfere with each other when controlling the heating of the first coil 111 and the second coil 112. Also, an unexpected induction heating operation may be performed when a change in inductance or impedance is detected through the first coil 111 and the second coil 112.

In one embodiment, the controller 120 may detect insertion of the aerosol generating article 20 based on an inductance change of the first coil 111 in the third period. Also, the controller 120 may detect insertion of the aerosol generating article 20 based on an inductance change of the second coil 112 in the fourth period. Specifically, the controller 120 may determine whether the aerosol generating article 20 is inserted in an accommodation space based on a frequency change corresponding to an inductance change of the first coil 111 or the second coil 112. In this case, the frequency change corresponding to the inductance change may be calculated by Equation 2 below.

$${f}_{0} = \frac{1}{2 π \sqrt{L C}} \qquad Equation 2$$

For example, the controller 120 may calculate a resonance frequency f_{O} according to inductance L of the first coil 111 or the second coil 112 through Equation 2. That is, when the aerosol generating article 20 is inserted into an induction coil, a value of the inductance L of the induction coil may decrease, and a value of the resonance frequency fo measured by the controller 120 may increase. In one embodiment, when a frequency value corresponding to an inductance change of the first coil 111 or the second coil 112 increases above a preset frequency change, the controller 120 may determine that the aerosol generating article 20 is inserted in an accommodation space.

In one embodiment, the controller 120 may calculate temperatures of the first susceptors 101 and 261 and temperatures of the second susceptors 102 and 262 by detecting a change in resonance frequency of the first coil 111 in the third period and detecting a change in resonance frequency of the second coil 112 in the fourth period.

Below, a principle of calculating the temperature of the first susceptor by detecting a change in resonance frequency of the second coil is first described with reference to FIGS. 3 to 11.

The controller 120 may drive the first coil 111 at a first driving frequency in the first period. The first driving frequency may be included in the first frequency range fr1. A current applied to the first coil 111 may change according to a first driving frequency for driving the first coil 111.

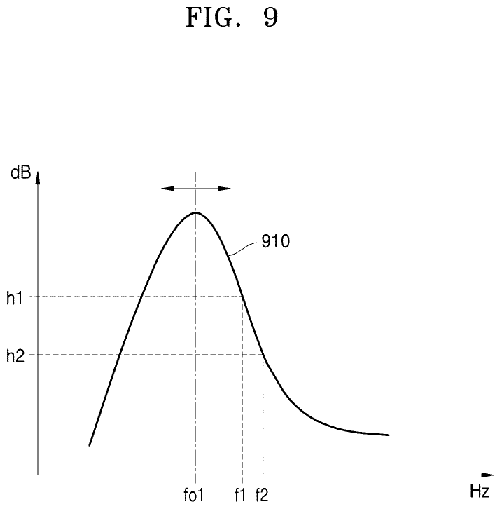

FIG. 9 illustrates a frequency response 910 of the first coil 111. In FIG. 9, the response magnitude of the first coil 111 may be the greatest at a first resonance frequency fo1. In other words, the current applied to the first coil 111 may be the greatest at the first resonance frequency fo1. The first resonance frequency fo1 may be determined by the first coil 111 and a first capacitor (not illustrated) connected in series to the first coil 111.

Also, the response magnitude of the first coil 111 may gradually decrease as the frequency increases, based on the first resonance frequency fo1. For example, the response magnitude h1 of the first coil 111 at a first frequency f1 greater than the first resonance frequency fo1 may be greater than a response magnitude h2 of the first coil 111 at a second frequency f2 greater than the first frequency f1.

The controller 120 may control a current applied to the first coil 111 by varying a driving frequency in the first frequency range fr1 in the first period. When the current applied to the first coil 111 varies, temperatures of the first susceptors 101 and 261 included in the aerosol generating article 20 or the aerosol generating device 10 may also vary.

For example, as the controller 120 sets a first driving frequency to the first resonance frequency fo1, the greatest power may be supplied to the first coil 111. Accordingly, temperatures of the first susceptors 101 and 261 may be heated to the highest temperature. In another example, the controller 120 may supply first power smaller than the greatest power to the first coil 111 by setting the first driving frequency to the first frequency f1 higher than the first resonance frequency fo1. Accordingly, temperatures of the first susceptors 101 and 261 may be heated to a first temperature lower than the highest temperature. In another example, the controller 120 may supply a second power smaller than the first power to the first coil 111 by setting the first driving frequency to the second frequency f2 higher than the first frequency f1. Accordingly, temperatures of the first susceptors 101 and 261 may be heated to a second temperature lower than the first temperature.

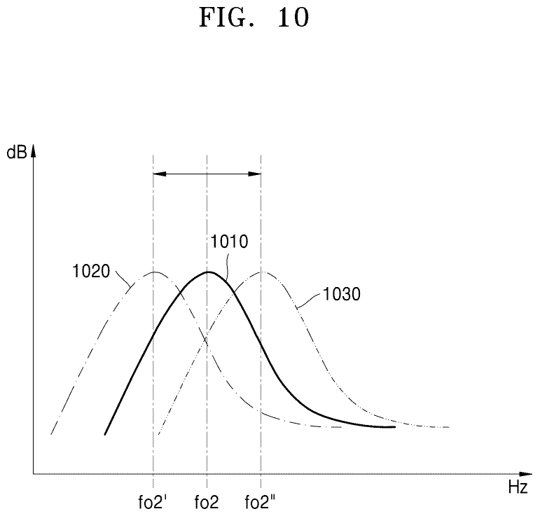

The controller 120 may detect a change in resonance frequency of the second coil 112 based on the fourth frequency range fr4 in the fourth period. Specifically, FIG. 10 illustrates frequency responses 1010, 1020, and 1030 of the second coil 112 according to temperature changes of the first susceptors 101 and 261. In FIG. 10, when the first susceptors 101 and 261 are at the first temperature, the response magnitude of the second coil 112 may be the best at the second resonance frequency fo2. The second resonance frequency fo2 may be determined by the second coil 112 and a second capacitor (not illustrated) connected in series to the second coil 112.

Also, the second resonance frequency fo2 of the second coil 112 may increase to fo2″ or decrease to fo2′ as temperatures of the first susceptors 101 and 261 increase. As the second resonance frequency fo2 varies, the frequency at which the greatest current is output may also vary. In the fourth period, the controller 120 may sweep the fourth driving frequency of the second coil 112 within the fourth frequency range fr4, and may detect the second resonance frequency fo2 of the second coil 112 based on the frequency sweeping result. For example, the controller 120 may sweep the fourth driving frequency of the second coil 112 within the fourth frequency range fr4 and determine a driving frequency when a current applied to the second coil 112 is the greatest as the second resonance frequency fo2.

In addition, when the fourth frequency range fr4 overlaps the first frequency range fr1, the first susceptors 101 and 261 may be inductively heated by the second coil 112. Because the induction heating of the first susceptors 101 and 261 by the second coil 112 corresponds to unexpected heating, the induction heating may cause inaccurate temperature control of the first susceptors 101 and 261. Therefore, it is preferable that the fourth frequency range fr4 does not overlap the first frequency range fr1.

Assuming an embodiment (see FIGS. 3 to 5) in which average thicknesses of the first susceptors 101 and 261 are greater than average thicknesses of the second susceptors 102 and 262, as illustrated in FIG. 8, it is preferable that the frequency increases in the order of the third frequency range fr3 for driving the first coil 111 in the third period which is the lowest frequency band, the first frequency range fr1 for driving the first coil 111 in the first period, the second frequency range fr2 for driving the second coil 112 in the second period, and the fourth frequency range fr4 for driving the second coil 112 in the fourth period which is the highest frequency band.

At an upper limit of the first frequency range fr1, the first susceptors 101 and 261 may be heated up to a first heating temperature by induction heating of the first coil 111, and at a lower limit of the fourth frequency range fr4, the first susceptors 101 and 261 may be heated up to a second heating temperature lower than the first heating temperature by induction heating of the second coil 112. An aerosol may not be generated at the second heating temperature.

In addition, when the lower limit of the fourth frequency range fr4 affects a temperature change of the first susceptors 101 and 261, the temperatures of the first susceptors 101 and 261 may vary even during the frequency sweep of the second coil 112. In this regard, the lower limit of the fourth frequency range fr4 may be set to a frequency that does not affect the temperature change of the first susceptors 101 and 261. For example, when the first frequency range fr1 is 0.1 MHz to 0.3 MHz, the fourth frequency range fr4 may be set to 2 MHz to 4 MHz. However, embodiments are not limited thereto. Also, average thicknesses of the first susceptors 101 and 261 may be designed by considering a relationship between the current penetration depth P and the frequency f of Equation 1 such that the lower limit of the fourth frequency range fr4 does not affect the temperature change of the first susceptors 101 and 261.

The controller 120 may calculate temperatures of the first susceptors 101 and 261 based on a change in resonance frequency of the second coil 112 in the fourth period.

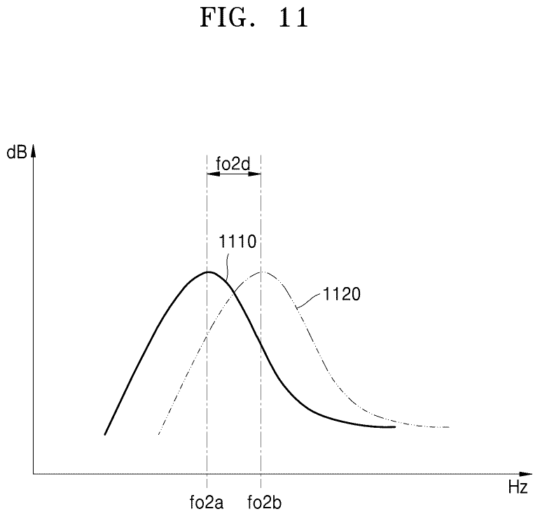

Specifically, FIG. 11 illustrates changes in frequency responses 1110 and 1120 of the second coil 112 according to temperature changes of the first susceptors 101 and 261. As the temperatures of the first susceptors 101 and 261 change, a frequency response of the second coil 112 changes from the first frequency response 1110 to the second frequency response 1120.

The controller 120 may calculate temperatures of the first susceptors 101 and 261 based on a frequency difference fo2d between a third resonance frequency fo2a of the second coil 112 detected at a first point in time of the fourth period and a fourth resonance frequency fo2b at a second point in time when a preset time elapses from the first point in time.

The controller 120 may calculate temperatures of the first susceptors 101 and 261 based on matching data of the resonance frequency difference fo2d and temperatures of the first susceptors 101 and 261. The matching data of the resonance frequency difference fo2d and the temperatures of the first susceptors 101 and 261 may be previously stored in a memory in the form of a lookup table.

Next, a principle of calculating temperatures of the second susceptors 102 and 262 by detecting a change in resonance frequency of the first coil 111 is described. The principle of calculating the temperatures of the second susceptors 102 and 262 by detecting a change in resonance frequency of the first coil 111 is similar to the principle of calculating the temperatures of the first susceptors 110 and 261 by detecting the change in resonance frequency of the second coil 112 described above.

The controller 120 may drive the second coil 112 at a second driving frequency in the second period. The second driving frequency may be included in the second frequency range fr2. A current applied to the second coil 112 may change according to the second driving frequency for driving the second coil 112.

The controller 120 may detect a change in resonance frequency of the first coil 111 based on the third frequency range fr3 in the third period. The resonance frequency of the first coil 111 may be determined by the first coil 111 and a first capacitor (not illustrated) connected in series to the first coil 111.

The resonance frequency of the first coil 111 may increase or decrease as temperatures of the second susceptors 102 and 262 increase. In the third period, the controller 120 may sweep the third driving frequency of the first coil 111 within the third frequency range fr3, and may detect the second resonance frequency of the first coil 111 based on the frequency sweeping result. For example, the controller 120 may sweep the third driving frequency of the first coil 111 within the third frequency range fr3 and determine a driving frequency when a current applied to the first coil 111 is the greatest as the second resonance frequency.

In addition, when the third frequency range fr3 overlaps the second frequency range fr2, the second susceptors 102 and 262 may be inductively heated by the first coil 111. Because the induction heating of the second susceptors 102 and 262 by the first coil 111 corresponds to unexpected heating, the induction heating may cause inaccurate temperature control of the second susceptors 102 and 262. Therefore, it is preferable that the fourth frequency range fr4 do not overlap the first frequency range fr1.

Assuming an embodiment (see FIGS. 3 and 4) in which average thicknesses of the first susceptors 101 and 261 are greater than average thicknesses of the second susceptors 102 and 262, as illustrated in FIG. 8, it is preferable that the frequency increases in the order of the third frequency range fr3 for driving the first coil 111 in the third period which is the lowest frequency band, the first frequency range fr1 for driving the first coil 111 in the first period, the second frequency range fr2 for driving the second coil 112 in the second period, and the fourth frequency range fr4 for driving the second coil 112 in the fourth period which is the highest frequency band.

At a lower limit of the second frequency range fr2, the second susceptors 102 and 262 may be heated up to a third heating temperature by induction heating of the second coil 112, and at an upper limit of the third frequency range fr3, the second susceptors 102 and 262 may be heated up to a fourth heating temperature lower than the third heating temperature by induction heating of the first coil 111. An aerosol may not be generated at the fourth heating temperature.

In addition, when the upper limit of the third frequency range fr3 affects a temperature change of the second susceptors 102 and 262, the temperatures of the second susceptors 102 and 262 may vary even during the frequency sweep of the first coil 111. In this regard, the upper limit of the third frequency range fr3 may be set to a frequency that does not affect the temperature change of the second susceptors 102 and 262. Also, average thicknesses of the second susceptors 102 and 262 may be designed by considering a relationship between the current penetration depth P and the frequency f of Equation 1 such that the upper limit of the third frequency range fr3 does not affect the temperature change of the second susceptors 102 and 262.

The controller 120 may calculate temperatures of the second susceptors 102 and 262 based on a change in resonance frequency of the first coil 111 in the third period.

The controller 120 may calculate temperatures of the second susceptors 102 and 262 based on a frequency difference between a resonance frequency of the first coil 111 detected at a first point in time of the third period and a resonance frequency at a second point in time when a preset time elapses from the first point in time.

The controller 120 may calculate the temperatures of the second susceptors 102 and 262 based on matching data of the resonance frequency difference of the first coil 111 and temperatures of the second susceptors 102 and 262. The matching data of the resonance frequency difference and the temperatures of the second susceptors 102 and 262 may be previously stored in a memory in the form of a lookup table.

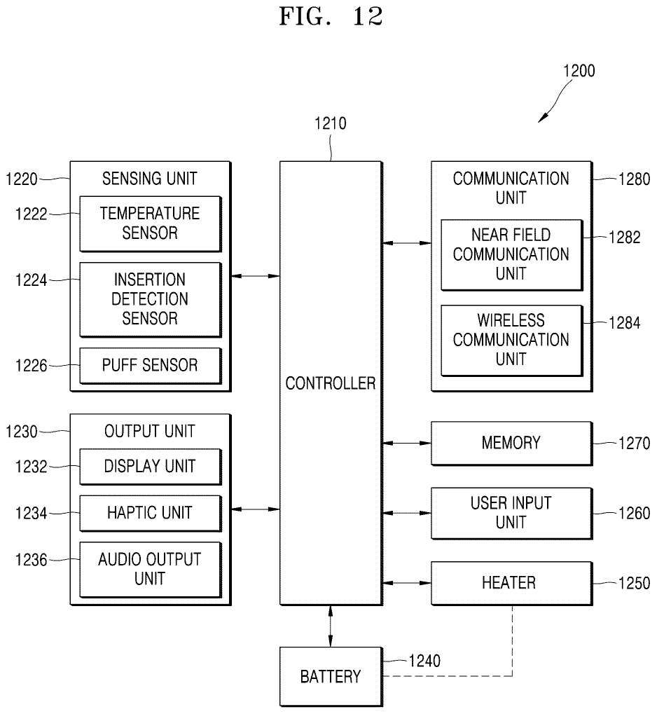

FIG. 12 is a block diagram of an aerosol generating device 1200 according to another embodiment.

The aerosol generating device 1200 may include a controller 1210, a sensing unit 1220, an output unit 1230, a battery 1240, a heater 1250, a user input unit 1260, a memory 1270, and a communication unit 1280. However, the internal structure of the aerosol generating device 1200 is not limited to those illustrated in FIG. 12. That is, according to the design of the aerosol generating device 1200, it will be understood by one of ordinary skill in the art that some of the components shown in FIG. 12 may be omitted or new components may be added.

The sensing unit 1220 may sense a state of the aerosol generating device 1200 and a state around the aerosol generating device 1200, and transmit sensed information to the controller 1210. Based on the sensed information, the controller 1210 may control the aerosol generating device 1200 to perform various functions, such as controlling an operation of the heater 1250, limiting smoking, determining whether an aerosol generating article (e.g., a cigarette, a cartridge, or the like) is inserted, displaying a notification, or the like.

The sensing unit 1220 may include at least one of a temperature sensor 1222, an insertion detection sensor, and a puff sensor 1226, but is not limited thereto.

The temperature sensor 1222 may sense a temperature at which the heater 1250 (or an aerosol generating material) is heated. The aerosol generating device 1200 may include a separate temperature sensor for sensing the temperature of the heater 1250, or the heater 1250 may serve as a temperature sensor. Alternatively, the temperature sensor 1222 may also be arranged around the battery 1240 to monitor the temperature of the battery 1240.

The insertion detection sensor 1224 may sense insertion and/or removal of an aerosol generating article. For example, the insertion detection sensor 1224 may include at least one of a film sensor, a pressure sensor, an optical sensor, a resistive sensor, a capacitive sensor, an inductive sensor, and an infrared sensor, and may sense a signal change according to the insertion and/or removal of an aerosol generating article. Also, in the aerosol generating device 1200, the heater 1250 itself may serve as the insertion detection sensor 1224.

The puff sensor 1226 may sense a user's puff on the basis of various physical changes in an airflow passage or an airflow channel. For example, the puff sensor 1226 may sense a user's puff on the basis of any one of a temperature change, a flow change, a voltage change, and a pressure change.

The sensing unit 1220 may include, in addition to the temperature sensor 1222, the insertion detection sensor 1224, and the puff sensor 1226 described above, at least one of a temperature/humidity sensor, a barometric pressure sensor, a magnetic sensor, an acceleration sensor, a gyroscope sensor, a location sensor (e.g., a global positioning system (GPS)), a proximity sensor, and a red-green-blue (RGB) sensor (illuminance sensor). Because a function of each of sensors may be intuitively inferred by one of ordinary skill in the art from the name of the sensor, a detailed description thereof may be omitted.

The output unit 1230 may output information on a state of the aerosol generating device 1200 and provide the information to a user. The output unit 1230 may include at least one of a display unit 1232, a haptic unit 1234, and a sound output unit 1236, but is not limited thereto. When the display unit 1232 and a touch pad form a layered structure to form a touch screen, the display unit 1232 may also be used as an input device in addition to an output device.

The display unit 1232 may visually provide information about the aerosol generating device 1200 to the user. For example, information about the aerosol generating device 1200 may mean various pieces of information, such as a charging/discharging state of the battery 1240 of the aerosol generating device 1200, a preheating state of the heater 1250, an insertion/removal state of an aerosol generating article, or a state in which the use of the aerosol generating device 1200 is restricted (e.g., sensing of an abnormal object), or the like, and the display unit 1232 may output the information to the outside. The display unit 1232 may be, for example, a liquid crystal display panel (LCD), an organic light-emitting diode (OLED) display panel, or the like. In addition, the display unit 1232 may be in the form of a light-emitting diode (LED) light-emitting device.

The haptic unit 1234 may tactilely provide information about the aerosol generating device 1200 to the user by converting an electrical signal into a mechanical stimulus or an electrical stimulus. For example, the haptic unit 1234 may include a motor, a piezoelectric element, or an electrical stimulation device.

The sound output unit 1236 may audibly provide information about the aerosol generating device 1200 to the user. For example, the sound output unit 1236 may convert an electrical signal into a sound signal and output the same to the outside.

The battery 1240 may supply power used to operate the aerosol generating device 1200. The battery 1240 may supply power such that the heater 1250 may be heated. In addition, the battery 1240 may supply power required for operations of other components (e.g., the sensing unit 1220, the output unit 1230, the user input unit 1260, the memory 1270, and the communication unit 1280) in the aerosol generating device 1200. The battery 1240 may be a rechargeable battery or a disposable battery. For example, the battery 1240 may be a lithium polymer (LiPoly) battery, but is not limited thereto.

The heater 1250 may receive power from the battery 1240 to heat an aerosol generating material. Although not illustrated in FIG. 12, the aerosol generating device 1200 may further include a power conversion circuit (e.g., a direct current (DC)/DC converter) that converts power of the battery 1240 and supplies the same to the heater 1250. In addition, when the aerosol generating device 1200 generates aerosols in an induction heating method, the aerosol generating device 1200 may further include a DC/alternating current (AC) that converts DC power of the battery 1240 into AC power.

The controller 1210, the sensing unit 1220, the output unit 1230, the user input unit 1260, the memory 1270, and the communication unit 1280 may each receive power from the battery 1240 to perform a function. Although not illustrated in FIG. 12, the aerosol generating device 1200 may further include a power conversion circuit that converts power of the battery 1240 to supply the power to respective components, for example, a low dropout (LDO) circuit, or a voltage regulator circuit.

In an embodiment, the heater 1250 may be formed of any suitable electrically resistive material. For example, the suitable electrically resistive material may be a metal or a metal alloy including titanium, zirconium, tantalum, platinum, nickel, cobalt, chromium, hafnium, niobium, molybdenum, tungsten, tin, gallium, manganese, iron, copper, stainless steel, nichrome, or the like, but is not limited thereto. In addition, the heater 1250 may be implemented by a metal wire, a metal plate on which an electrically conductive track is arranged, a ceramic heating element, or the like, but is not limited thereto.

In another embodiment, the heater 1250 may be a heater of an induction heating type. For example, the heater 1250 may include a susceptor that heats an aerosol generating material by generating heat through a magnetic field applied by a coil.

In another embodiment, the heater 1250 may include two or more heaters. For example, the heater 1250 may include a first heater and a second heater. The first heater may include a first coil and a first susceptor that is inductively heated from the first coil, and the second heater may include a second coil and a second susceptor that is inductively heated from the second coil. By setting the driving frequencies of the first coil and the second coil differently and designing the average thickness of the first susceptor and the second susceptor to be different, the first coil inductively heats the second susceptor, or the second coil inductively heats the second susceptor. 1Cross-heating by induction heating of the susceptor may be minimized.

The user input unit 1260 may receive information input from the user or may output information to the user. For example, the user input unit 1260 may include a key pad, a dome switch, a touch pad (a contact capacitive method, a pressure resistance film method, an infrared sensing method, a surface ultrasonic conduction method, an integral tension measurement method, a piezo effect method, or the like), a jog wheel, a jog switch, or the like, but is not limited thereto. In addition, although not illustrated in FIG. 12, the aerosol generating device 1200 may further include a connection interface, such as a universal serial bus (USB) interface, and may connect to other external devices through the connection interface, such as the USB interface, to transmit and receive information, or to charge the battery 1240.

The memory 1270 is a hardware component that stores various types of data processed in the aerosol generating device 1200, and may store data processed and data to be processed by the controller 1210. In one embodiment, matching data of a resonance frequency difference of the first coil and the temperature of the second susceptor may be stored in the memory 1270 in the form of a lookup table. The matching data of a resonance frequency difference of the second coil and the temperature of the first susceptor may also be stored in the memory 1270 in the form of a lookup table.

The memory 1270 may include at least one type of storage medium from among a flash memory type, a hard disk type, a multimedia card micro type memory, a card-type memory (for example, secure digital (SD) or extreme digital (XD) memory, etc.), random access memory (RAM), static random access memory (SRAM), read-only memory (ROM), electrically erasable programmable read-only memory (EEPROM), programmable read-only memory (PROM), a magnetic memory, a magnetic disk, and an optical disk. The memory 1270 may store an operation time of the aerosol generating device 1200, the maximum number of puffs, the current number of puffs, at least one temperature profile, data on a user's smoking pattern, etc.

The communication unit 1280 may include at least one component for communication with another electronic device. For example, the communication unit 1280 may include a short-range wireless communication unit 1282 and a wireless communication unit 1284.

The short-range wireless communication unit 1282 may include a Bluetooth communication unit, a Bluetooth Low Energy (BLE) communication unit, a near field communication unit, a wireless LAN (WLAN) (Wi-Fi) communication unit, a Zigbee communication unit, an infrared data association (IrDA) communication unit, a Wi-Fi Direct (WFD) communication unit, an ultra-wideband (UWB) communication unit, an Ant+ communication unit, or the like, but is not limited thereto.

The wireless communication unit 1284 may include a cellular network communication unit, an Internet communication unit, a computer network (e.g., local area network (LAN) or wide area network (WAN)) communication unit, or the like, but is not limited thereto. The wireless communication unit 1284 may also identify and authenticate the aerosol generating device 1200 within a communication network by using subscriber information (e.g., International Mobile Subscriber Identifier (IMSI)).

The controller 1210 may control general operations of the aerosol generating device 1200. In an embodiment, the controller 1210 may include at least one processor. The processor may be implemented as an array of a plurality of logic gates or may be implemented as a combination of a general-purpose microprocessor and a memory in which a program executable by the microprocessor is stored. It will be understood by one of ordinary skill in the art that the processor may be implemented in other forms of hardware.

The controller 1210 may control the temperature of the heater 1250 by controlling the supply of power from the battery 1240 to the heater 1250. For example, the controller 1210 may control the supply of power by controlling switching of a switching device between the battery 1240 and the heater 1250. In another example, a heating integrated circuit may control the supply of power to the heater 1250 according to a control command from the controller 1210.

The controller 1210 may analyze the result detected by the sensing unit 1220 and control subsequent processing. For example, the controller 1210 may control the power supplied to the heater 1250 to start or end an operation of the heater 1250 based on the result detected by the sensing unit 1220. For example, the controller 1210 may control the power supplied to the heater 1250 and the time at which power is supplied based on the result detected by the sensing unit 1220 such that the heater 1250 may be heated to a preset temperature or maintain an appropriate temperature.

The controller 1210 may control the output unit 1230 based on the result detected by the sensing unit 1220. For example, when the number of puffs counted by the puff sensor 1226 reaches a preset number, the controller 1210 may notify a user that the aerosol generating device 1200 will soon be shut down through at least one of the display unit 1232, the haptic unit 1234, and the sound output unit 1236.

One embodiment may also be implemented in the form of a computer-readable recording medium including instructions executable by a computer, such as a program module executable by the computer. The computer-readable recording medium may be any available medium that may be accessed by a computer and includes both volatile and nonvolatile media, and removable and non-removable media. In addition, the computer-readable recording medium may include both a computer storage medium and a communication medium. The computer storage medium includes all of volatile and nonvolatile media, and removable and non-removable media implemented by any method or technology for storage of information such as computer-readable instructions, data structures, program modules, or other data. The communication medium typically includes computer-readable instructions, data structures, other data in modulated data signals such as program modules, or other transmission mechanisms, and includes any information transfer media.

The descriptions of the above-described embodiments are merely examples, and it will be understood by one of ordinary skill in the art that various changes and equivalents thereof may be made. Therefore, the scope of the disclosure should be defined by the appended claims, and all differences within the scope equivalent to those described in the claims will be construed as being included in the scope of protection defined by the claims.

1. An aerosol generation system comprising:
an aerosol generating article; and
an aerosol generating device configured to heat the aerosol generating article inserted into an accommodation space of the aerosol generating device,
wherein the aerosol generating article includes a first susceptor arranged in a first portion and a second susceptor arranged in a second portion different from the first portion,
the aerosol generating device includes a first coil arranged in a first region of the accommodation space, a second coil arranged in a second region of the accommodation space, wherein the second region is different from the first region, and a controller configured to control power supplied to the first coil and the second coil,
an average thickness of the first susceptor is greater than an average thickness of the second susceptor,
the controller is further configured to drive the first coil within a first frequency range in a first period and drive the second coil within a second frequency range in a second period, and
a lower limit of the second frequency range is greater than an upper limit of the first frequency range.

2. The aerosol generating system of claim 1, wherein a minimum thickness of the first susceptor is greater than a maximum thickness of the second susceptor.

3. The aerosol generating system of claim 1, wherein the first susceptor and the second susceptor are each formed in a shape of a thin film.

4. The aerosol generating system of claim 1, wherein the first period does not overlap the second period.

5. The aerosol generating system of claim 1, wherein the controller is further configured to detect an inductance change through the first coil in a third period that does not overlap the first period, or detect an inductance change through the second coil in a fourth period that does not overlap the second period.

6. The aerosol generating system of claim 5, wherein the controller is further configured to determine, based on the inductance change, whether the aerosol generating article is inserted in the accommodation space.

7. The aerosol generating system of claim 5, wherein
the first period does not overlap the second period, and
the second period at least partially overlaps the third period, or the first period at least partially overlaps the fourth period.

8. The aerosol generating system of claim 1, wherein the controller is further configured to:
sweep a driving frequency of the first coil within a third frequency range in a third period that does not overlap the first period,
detect a change in a resonance frequency of the first coil based on a sweeping result of the driving frequency of the first coil,
sweep a driving frequency of the second coil within a fourth frequency range in a fourth period that does not overlap the second period, and
detect a change in a resonance frequency of the second coil based on a sweeping result of the driving frequency of the second coil.

9. The aerosol generating system of claim 8, wherein the controller is further configured to calculate temperatures of the first susceptor and the second susceptor based on the change in the resonance frequency of the first coil and the change in the resonance frequency of the second coil.

10. The aerosol generating system of claim 8, wherein
an upper limit of the third frequency range is lower than a lower limit of the first frequency range, and
a lower limit of the fourth frequency range is higher than an upper limit of the second frequency range.

11. An aerosol generating device comprising:
an accommodation space for accommodating an aerosol generating article;
a first susceptor arranged in a first region of the accommodation space;
a second susceptor arranged in a second region of the accommodation space that is different from the first region;
a first coil wound on an outer side surface of the first region of the accommodation space;
a second coil wound on an outer side surface of the second region of the accommodation space; and
a controller configured to control power supplied to the first coil and the second coil,
wherein an average thickness of the first susceptor is greater than an average thickness of the second susceptor,
the controller is further configured to drive the first coil within a first frequency range in a first period and drive the second coil within a second frequency range in a second period, and
a lower limit of the second frequency range is higher than an upper limit of the first frequency range.

12. The aerosol generating device of claim 11, wherein a minimum thickness of the first susceptor is greater than a maximum thickness of the second susceptor.

13. The aerosol generating device of claim 11, wherein the controller is further configured to detect an inductance change through the first coil in a third period that does not overlap the first period, or detect an inductance change through the second coil in a fourth period that does not overlap the second period.

14. The aerosol generating device of claim 11, wherein the controller is further configured to:
sweep a driving frequency of the first coil within a third frequency range in a third period that does not overlap the first period,
detect a change in a resonance frequency of the first coil based on a sweeping result of the driving frequency of the first coil,
sweep a driving frequency of the second coil within a fourth frequency range in a fourth period that does not overlap the second period, and
detect a change in a resonance frequency of the second coil based on a sweeping result of the driving frequency of the second coil.

15. The aerosol generating device of claim 14, wherein
an upper limit of the third frequency range is lower than a lower limit of the first frequency range, and
a lower limit of the fourth frequency range is higher than an upper limit of the second frequency range.
